(19) United States
(12) Patent Application Publication
(10) Pub. No.: US 2007/0133519 A1
(43) Pub. Date: Jun. 14, 2007

(54) Method and apparatus for network-based call screening for interrupting packet data calls

(75) Inventors: Cynthia Kae Florkey, Chicago, IL (US); Ruth Schaefer Gayde, Naperville, IL (US); Mathew Alexander Kaustinen, Overland Park, KS (US); Patrick Jay Walsh, Naperville, IL (US); Shawn S. Yu, Naperville, IL (US)

Correspondence Address: JENNER & BLOCK LLP, ONE IBM PLAZA, CHICAGO, IL, 60611, US

(73) Assignee: Lucent Technologies Inc.

(21) Appl. No.: 11/301,498

(22) Filed: Dec. 13, 2005

(51) Int. Cl. H04L 12/66; H04L 12/56

(52) U.S. Cl. 370/352; 370/401

(57) ABSTRACT

A user of a telecommunications device (102), such as a wireless terminal, or the like, selects certain actions that should be taken when a circuit call is received while a packet data session is active (200). These actions include interrupting the packet data session, or not interrupting the packet data session, which may be determined based on stored options specific to the subscriber and/or a query to the subscriber device (216). When a switching system detects that a subscriber device has an incoming circuit call during an active packet data session, the switching system queries a subscriber database and determines the appropriate action to take (210, 212, 214). The appropriate action is based on, for example, the calling number, time of day, date, duration of the packet data session, an instantaneous or simultaneous query to the subscriber device or a type of packet data session that is active. Once the appropriate action is determined (216), either the packet data session is not interrupted and secondary treatment may be applied to the incoming call (218), or the packet data session is interrupted and the circuit call is paged to the subscriber device in the traditional manner (222) and traditional treatment is thereafter applied (224).

### FIELD OF THE INVENTION

The present invention relates generally to telecommunications systems, and in particular, to a network-based method and apparatus for screening calls before interrupting a packet data call.

### BACKGROUND OF THE INVENTION

Second and third generation wireless communication networks offer packet data services to customers with mobile terminals capable of receiving such services. Generally, to receive packet data services, the mobile terminal must obtain a data traffic channel and enter into a packet data session. During this session, packets of data are transmitted between the mobile terminal and the wireless communications system.

While many wireless communications systems and associated mobile terminals have support in their standards for receiving packet data calls and circuit switched calls simultaneously, as a practical matter, most wireless communications systems and associated mobile terminals only implement support for a single packet data channel or a single circuit switched channel at any particular time. An example of such a system is the well-known Code Division Multiple Access (CDMA) communication system. As deployed, these systems allow a single packet data channel or a single circuit switched channel. If a customer is engaged in a packet data call or session and someone places a circuit switched call to that customer, then a choice must be made either to interrupt the packet data call and proceed with the circuit switched call, or reject the incoming circuit switched call, including applying any secondary treatment, such as, voicemail, call forwarding, or an announcement.

As opposed to the communications system automatically permitting or rejecting circuit switched calls during packet data sessions, U.S. Patent Application Number 20040022209, to Misra et al.(“Misra”) suggests setting a feature value under control of a mobile user to be used in call processing to determine whether to reject or receive a circuit call when a mobile terminal is involved in a packet data session. While Misra is an improvement over automatic rejection or interruption, Misra does not permit a user to make decisions with respect to the type of packet data call in progress, nor with respect to any characteristics of the incoming circuit call. This may be limiting, in particular, in the situation where the mobile user may very well not want to be interrupted while engaged in certain packet data calls, for example a voice over IP call, but may want to be interrupted while engaged in other packet data calls, for example, a packet data session involving the download of a file. Also, the mobile user may want to be interrupted with calls from certain parties but not others, or at certain times, but not others.

Therefore a need exists for a method and apparatus for a user to more precisely control and have additional options for determining whether an ongoing packet data call should be interrupted by a circuit switched call.

### SUMMARY OF THE INVENTION

The need is met and an advance in the art is made by the present invention, which permits the user of a wireless communications systems to subscribe to a service that controls, based on the type of ongoing packet data call or other conditions, whether an ongoing packet data call is interrupted.

According to the invention, a method is provided for determining whether to interrupt an active packet data session, if an incoming circuit call intended for a mobile terminal is received. A determination is made as to whether the mobile terminal is engaged in an active packet data session. If the mobile terminal is engaged in an active packet data session, then treatment for the incoming call is determined. Preferably, communication with another network element determines treatment for the incoming circuit call through predefined logic. And, the network element, through the predefined logic, provides a response that determines whether to interrupt the active packet data session. The predefined logic is preferably based on a call type for the active packet data session.

A system that implements the method includes a processor under control of a stored program. Under control of the processor and program, the system receives an incoming circuit call for a subscriber device and determines whether the device is engaged in an active packet data session and a call type, for example, voice over IP, for the active packet data session. According to the call type and other factors, including, for example, a time of day, a day of the week, a date, a calling telephone number, or a duration of the packet data session, or a query to the mobile terminal, as determined by predefined logic, the system determines whether to interrupt the active packet data session and page the subscriber device for the incoming circuit call.

### BRIEF DESCRIPTION OF THE DRAWINGS

FIG. 1 is a block diagram of a preferred embodiment of a wireless communications system in accordance with an embodiment of the present invention.

FIG. 2A and 2B are a flow chart illustrating a method for determining whether to interrupt an active packet data session for an incoming circuit call in accordance with an embodiment of the present invention.

### DETAILED DESCRIPTION OF THE PREFERRED EMBODIMENTS

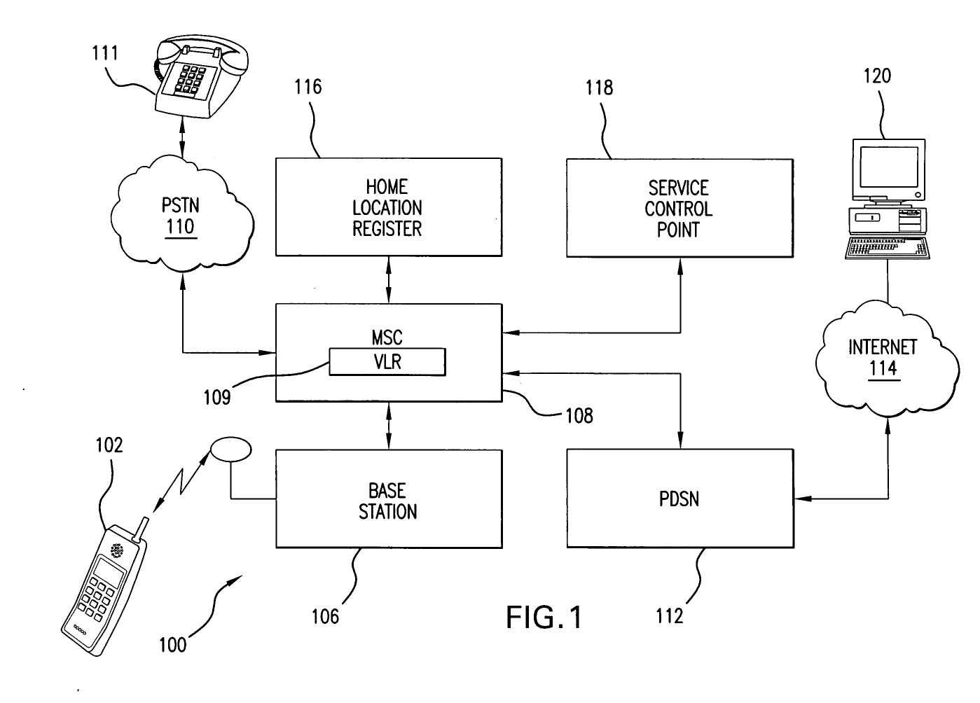

FIG. 1 is a block diagram of a wireless telecommunications system in accordance with an embodiment of the present invention. Wireless telecommunications system 100 includes wireless communications device 102, base station 106, mobile switching center (MSC) 108 and public switched telephone network (PSTN) 110. Wireless communications device 102 communicates with base station 106 over-the-air. Base station 106 is coupled to MSC 108 via data links. MSC 108 is coupled to the PSTN 110 via data links. Base station 106 extends communications from device 102 to MSC 108. Similarly, base station 106 extends communications from MSC 108 to device 102. MSC 108 receives communications from and extends communications to the PSTN 110. The PSTN 110 couples many devices to each other and to MSC 108 for communication. For example, a telephone 111 is coupled to MSC 108 via PSTN 110.

Wireless telecommunications system 100 also includes a packet data serving node (PDSN) 112, which couples MSC 108 to the Internet 114 or another packet data network for packet communications. A data link couples PDSN 112 to MSC 108. Wireless communications system 100 also includes a home location register 116 and a service control point 118, both of which store subscriber data.

In accordance with an embodiment of the present invention, when device 102 is engaged in a packet data session through MSC 108, if an incoming circuit call is received for device 102, then based on the type of ongoing packet data session and certain parameters stored in a subscriber database, such as home location register 116 and/or service control point 118, a decision is made as to whether to interrupt the ongoing packet data session for the incoming circuit call.

Wireless telecommunications system 100 is shown in FIG. 1 with only one each of telephone 111, device 102, base station 106, MSC 108, PSDN 112, home location register 116 and service control point 118. However, there may be many of these devices associated with wireless telecommunications system 100, as is well-known to those skilled in the art.

Device 102 is preferably a wireless or cellular telephone, computer, personal digital assistant or the like. Device 102 is capable of communicating with MSC 108 via a packet data session or a circuit call. Device 102 may use any of a number of protocols including CDMA, GSM, or UMTS for circuit or packet communications. For example, device 102 may have a circuit connection to telephone 111 via PSTN 110 to facilitate voice communications. Or, device 108 may engage in packet communications with a computer 120 via Internet 114.

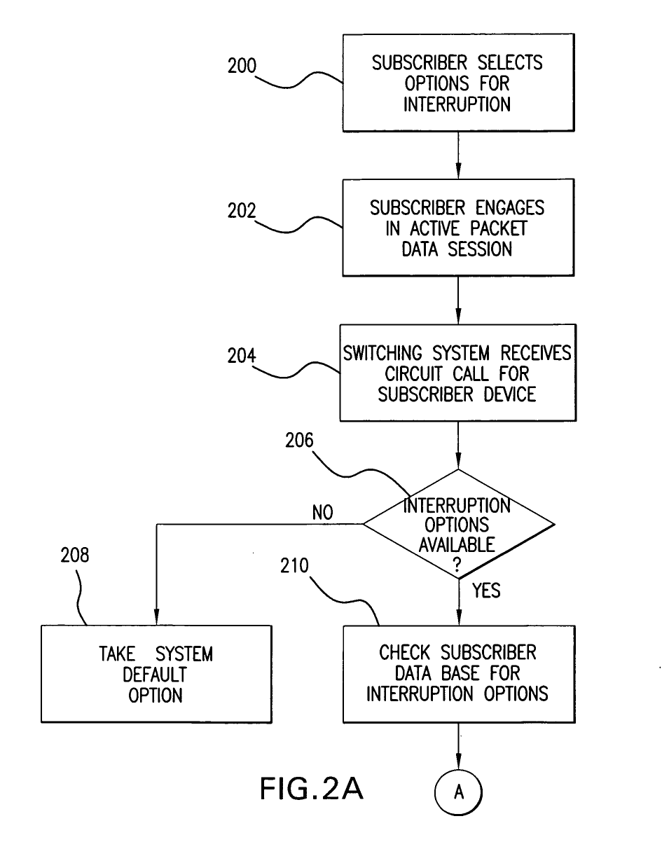

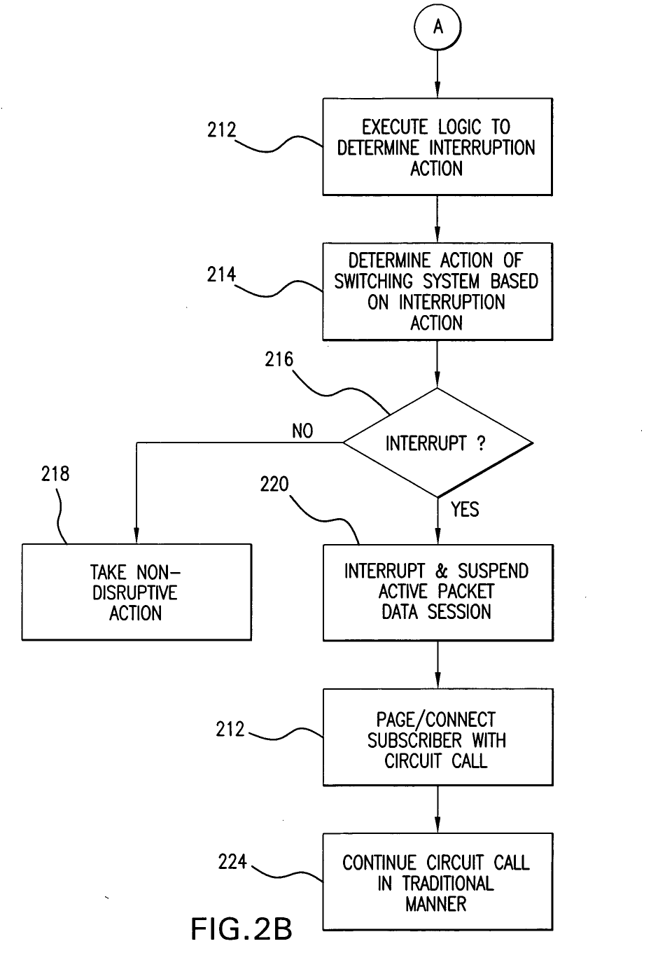

MSC 108 preferably includes one or more processors for controlling the functions of MSC 108 in response to a stored program. The processor preferably executes software code to perform functions in accordance with an embodiment of the present invention. In particular, MSC 108 is programmed to determine if an ongoing packet data session for a device coupled to the MSC should be interrupted if an incoming circuit call is received for that same device. In making this determination, MSC 108 may rely upon a subscriber database and/or internal logic. Exemplary operation of wireless communications system 100 in accordance with an embodiment of the invention is explained below with respect FIG. 2A and FIG. 2B.

FIG. 2A and FIG. 2B are a flow chart illustrating a preferred method of the present invention for determining whether to interrupt an ongoing packet data session if an incoming circuit call is received in accordance with the present invention.

According to an embodiment of the invention, a subscriber is permitted to select options for treatment of incoming circuit calls when a packet data session is ongoing (200). For example, a subscriber may elect to have certain types of packet data sessions always interrupted for circuit calls. Or, a subscriber may elect to have packet data sessions interrupted for incoming circuit calls based on a time of day, calling number, duration of the packet data session, or a response to a query made to the subscriber's device at the time of the incoming call. The options for treatment may be provisioned in any known manner, for example, by a service provider, via the wireless device, or via the Internet. Preferably, the options are stored in a subscriber database, for example, a service control point.

According to one embodiment, a subscriber engages in a packet data session (202). This packet data session is, for example, a voice over IP (VoIP) call or a download of data from the Internet 114. The packet data session is established via MSC 108 via any of a number of methods known to those of skill in the art. This is often accomplished by dialing or selecting a predetermined sequence of key digits in a browser or selecting other options, such as menu options, on wireless communications device 102.

Next, the MSC 108 detects an incoming circuit call for the device 102 that is engaged in a packet data session (204). The MSC 108, upon determining that device 102 is engaged in a packet data session and an incoming circuit call is destined for device 102, determines the appropriate action to take. In one embodiment, where a subscriber may have options or may not have options to determine whether to interrupt the packet data session, the MSC 108 preferably checks to determine whether options for handling the incoming circuit call are available. That is, the MSC 108 determines whether the subscriber has options for determining interruption actions available (206). Preferably, MSC 108 communicates with a subscriber database that stores data that reflects whether interruption options are available. This subscriber database is, for example, visitor location register (VLR) 109, or home location register 116.

In the case where there are no interruption options available for the subscriber's device (206), then the system default action is taken (208). For example, the system default action is to always send the circuit call to secondary treatment, such as voice mail. Alternatively, the system default action is to interrupt the packet data session.

In the case where there are interruption options available to the subscriber device (206), then preferably, a subscriber database is queried to determine the interruption options (210). In a preferred embodiment, this subscriber database is SCP 118 and the query is made by the MSC 108. Alternatively, the query includes communications with an application server. The query preferably includes certain information that may be required to determine the appropriate interruption option, for example, the calling number and information about the ongoing packet data session, such as the duration of the packet data session and the call type for the packet data session. The call type for a packet data session is determined in any known manner, including in any manner disclosed in U.S. Patent Application No. 20040196786 to Laha et al., which is hereby incorporated by reference.

Based on the options stored in the database, and preferably, information transmitted by the MSC 108 regarding the call, such as, the type of packet data session, etc., a determination is made as to the appropriate action to take. In a preferred embodiment, the subscriber database, for example SCP 118 executes logic to determine the appropriate interruption action to take. Alternatively, the MSC 108 receives a response from the subscriber database that includes data for the MSC 108 to execute logic to determine the appropriate interruption action to take. Another alternative is to use a response from an application server to determine the appropriate interruption action. The appropriate interruption action, i.e., whether and how to interrupt the active packet data call, may vary. This is a static decision based solely upon the information from the subscriber database and the information provided by the MSC 108 (210), or this is a dynamic decision made with regard to instantaneous input (i.e., input at the time of the incoming call) from the user. In the case where instantaneous user input is desirable, MSC 108 sends an alert to the subscriber device to alert the user of the impending circuit call. And, the user provides a response, through the subscriber device, to the MSC that enables the MSC to determine the appropriate interruption action (214). This is preferably accomplished by interjecting an alert, such as a visual or audio alert or both, using the ongoing packet data session or a control channel. This action may be analogous to a traditional call waiting alert from the users' perspective. Of course, if instantaneous user input is not desired, then there is no need to alert a user and receive a response prior to taking the appropriate action.

The action that is taken may involve interrupting the active packet data session or not (216). If the appropriate action is not to interrupt the active packet data call, as may be the case if a VoIP call session is ongoing, for example, then non-disruptive action is taken (218). This preferably includes secondary treatment specific to the subscriber device, such as forwarding the call to voice mail or another device or denying the call and returning the appropriate indication, such as a busy signal.

If the appropriate action is to interrupt the call, then the ongoing packet data session is interrupted or ended (220). This preferably includes suspending the ability of the subscriber device to retry the packet data session to prevent race conditions and the like, and causing the subscriber device to enter into a dormant state, as discussed in U.S. Patent Application Number 20040022209, to Misra et al.(“Misra”), which is hereby incorporated herein by reference. After interruption of the ongoing packet data session, the subscriber device is alerted of the incoming circuit call. This is preferably accomplished by paging the subscriber device in the traditional manner for any incoming circuit call. Then further traditional treatment of the circuit call, for example, connecting the call or forwarding the call for secondary treatment, is applied.

The present invention permits a user to predetermine whether and how incoming circuit calls are treated when a subscriber device is engaged in a packet data call or session. Advantageously, the determination is based upon predetermined user input, preferably including the type of ongoing packet data session. Additionally, a user may be queried or alerted for a response. This provides subscriber flexibility in light of the varying nature of packet data calls or sessions.

Whereas the present invention has been described with respect to specific embodiments thereof, it will be understood that various changes and modifications will be suggested to one skilled in the art and it is intended that the invention encompass such changes and modifications as fall within the scope of the appended claims. In particular, as discussed above, the wireless communications system is a preferred embodiment of the invention, but the invention is applicable to other non-wireless communications systems, especially systems where there is typically only one channel per user device for two-way communication and that channel is either a circuit or packet channel, but not both simultaneously.

1. A method for determining whether to interrupt a packet data session, the method comprising the steps of:
receiving an incoming circuit call intended for a user device;
determining whether the user device is engaged in an active packet data session;
communicating with a network element to determine a treatment for the incoming circuit call;
based on a response from the network element, determining whether to interrupt the active packet data session.

2. The method of claim 1 further comprising the step of:
determining a call type for the active packet data session; and
wherein the step of communicating with the network element includes forwarding the call type to the network element; and
wherein the step of determining whether to interrupt the active packet data session is in part dependent on the call type.

3. The method of claim 1 wherein the response from the network element is based in part on at least one of: a calling number, a time of day, a day of a week, a duration of the active packet data session or a response from a server.

4. The method of claim 1 further comprising the step of:
interrupting the active packet data session.

5. The method of claim 4 wherein the step of interrupting the active packet data session further comprises:
sending a message to the user device to prevent race conditions;
causing the user device to enter a dormant state; and
paging the user device for the incoming circuit call.

6. The method of claim 1 wherein the step of determining whether to interrupt is executed by a mobile switching system.

7. The method of claim 1 wherein the step of determining whether to interrupt is executed by a subscriber database.

8. The method of claim 1 wherein the step of determining whether to interrupt is executed by a service control point.

9. The method of claim 1 wherein the network element is one of: a visitor location register or a home location register.

10. The method of claim 1 wherein the network element is a service control point.

11. The method of claim 1 wherein determining whether to interrupt the active packet data session includes sending an alert to a subscriber device and receiving a response from the subscriber device.

12. A telecommunication switching system comprising:
a processor that:
receives an incoming circuit call intended for a subscriber device;
determines whether the subscriber device is engaged in an active packet data session;
communicates with a network element to determine a treatment for the incoming circuit call, if the subscriber device is engaged in an active packet data session; and
based on a response from the network element, determines whether to interrupt the active packet data session.

13. The system of claim 12 wherein the processor also:
determines a call type for the active packet data session; and
wherein the processor communicating with the network element includes forwarding the call type to the network element; and
wherein the processor determining whether to interrupt the active packet data session is in part dependent on the call type.

14. The system of claim 12 wherein the response from the network element is based in part on one of: a calling number, a time of day, a day of a week, a date, a duration of the active packet data session or another response from a server.

15. The system of claim 12 further comprising the processor interrupting the active packet data session.

16. The system of claim 15 wherein the processor interrupting the active packet data session includes the first processor:
sending a message to the subscriber device to prevent race conditions;
causing the subscriber device to enter a dormant state; and
paging the subscriber device for the incoming circuit call.

17. The system of claim 12 wherein the network element is a home location register, a visitor location register or a service control point.

18. The system of claim 12 wherein the processor initiates an alert to the subscriber device and receives a response from the subscriber device.
